(19) United States
(12) Patent Application Publication
(10) Pub. No.: US 2007/0250293 A1
(43) Pub. Date: Oct. 25, 2007

(54) Motor vehicle control device

(75) Inventors: Hans-Thomas Lehr, Muehlacker-Grossglattbach (DE); Stephen Pelters, Tiefenbronn (DE)

Correspondence Address: LERNER GREENBERG STEMER LLP, P O BOX 2480, HOLLYWOOD, FL, 33022-2480, US

(73) Assignee: Dr. Ing. h.c. F. Porsche AG

(21) Appl. No.: 11/788,993

(22) Filed: Apr. 23, 2007

(30) Foreign Application Priority Data
Apr. 22, 2006 (DE) 102006018759.8-34

(51) Int. Cl. G06F 19/00; G06F 17/40

(52) U.S. Cl. 702/187; 702/189; 701/1; 701/29; 701/99; 701/101; 701/102; 701/115

(57) ABSTRACT

A motor vehicle control device, in particular an engine control device or gearbox controller, has an interface for receiving at least one measured variable, a device for calculating at least one variable and a memory for storing the measured variable or each measured variable and/or the calculated variable or each calculated variable. The measured variable(s) and/or the calculated variable(s) can be stored on the basis of at least one freely definable trigger condition, specifically in such a way that, for the respective variable to be stored, it is possible to define a number and width of classes and intervals for the variable, wherein if the respective variable to be stored falls in one of the classes, a counter reading for this class is increased by a defined absolute amount.

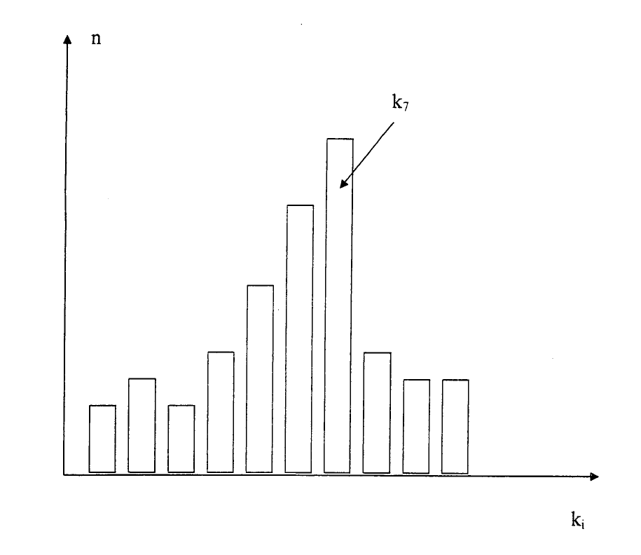

### CROSS-REFERENCE TO RELATED APPLICATION

This application claims the priority, under 35 U.S.C. § 119, of German application DE 10 2006 018 759.8, filed Apr. 22, 2006; the prior application is herewith incorporated by reference in its entirety.

### BACKGROUND OF THE INVENTION

### Field of the Invention

The invention relates to a motor vehicle control device, in particular engine control device or gearbox control device. The device has means for receiving at least one measured variable, means for calculating at least one variable, and means for storing the measured variable or each measured variable and/or the calculated variable or each calculated variable.

Motor vehicles have different control devices for performing open-loop or closed-loop control of components of a motor vehicle. It is thus possible, for example, to control the operation of a drive assembly of a motor vehicle by means of an engine control device. A gearbox, for example, is usually assigned a separate gearbox control device.

Motor vehicle control devices which are known from practice have means for receiving at least one measured variable, means for calculating at least one variable and means for storing the measured variable or each measured variable and/or the calculated variable or each calculated variable. An engine control device receives, for example, an actual rotational speed for the drive assembly as the measured variable. Variables for actuating manipulated variables for the drive assembly, for example manipulated variables for actuating injection valves, can be calculated from this measured actual rotational speed and further variables. In addition, measured and calculated variables can be stored in the engine control device.

German published patent application DE 102 49 659 A1 (WO 2004/038360 A1) discloses an engine control device to which a measuring station can be coupled via an interface. It is thereby possible to automatically carry out diagnostic routines stored in the control device by way of a group diagnostic call of the measuring station in order to test the motor vehicle. To do this, the control device intervenes actively in the operation of the motor vehicle in order, for example, to test the drive assembly of the motor vehicle.

### BRIEF SUMMARY OF THE INVENTION

It is accordingly an object of the invention to provide a motor vehicle control device, which overcomes the disadvantages of the heretofore-known devices and methods of this general type.

With the foregoing and other objects in view there is provided, in accordance with the invention, a motor vehicle control device, such as an engine control unit or a gearbox controller. The device comprises:

an input for receiving at least one measured variable;

means for calculating at least one variable to define a calculated variable;

a memory for storing the at least one measured variable and/or the calculated variable, wherein the measured variable and/or the calculated variable is stored on a basis of one or more freely defined trigger conditions, wherein, for a respective variable to be stored, a number and width of classes and intervals are defined for the variable, and, if the respective variable to be stored falls into one of the classes, a counter reading for the class is increased by a defined amount.

In accordance with an added feature of the invention, when the counter reading has reached a maximum permissible value in one of the classes for a variable to be stored, the counter readings of all classes corresponding to the variable to be stored are reduced by a common factor.

In accordance with an additional feature of the invention, when the counter reading has reached a maximum permissible value in at least one of the classes for a variable to be stored, the functionality of the motor vehicle control device is modified and/or a warning message is generated.

In accordance with a further feature of the invention, when the respective variable to be stored falls in a given class, the counter reading for the given class is increased by 1, and when the counter reading has reached a maximum permissible value, the counter readings of all the corresponding classes for the given variable to be stored are halved.

In accordance with an another feature of the invention, wherein a time interval and/or events which occur during operation are defined as a trigger condition.

In accordance with yet an added feature of the invention a plurality of trigger conditions are combined with one another.

In accordance with yet an additional feature of the invention, wherein the variable or each variable is stored in the form of a histogram. In a preferred embodiment, the histogram is stored in an engine control unit and it is deleted only after a request by an external command or after a defined state has been reached.

Preferably, and in accordance with a concomitant feature of the invention, the histogram is stored in a volatile memory and in a nonvolatile memory.

With the above and other objects in view there is also provided, in accordance with the invention, a method of operating a motor vehicle control device, comprising:

receiving at least one measured variable related to an operation of the vehicle in the motor vehicle control device;

calculating at least one calculated variable from the measured variable;

storing the at least one measured variable and/or the calculated variable on a basis of one or more freely definable trigger conditions;

defining, for a respective variable to be stored, a number and a width of classes and intervals; and

if the respective variable to be stored falls into one of the classes, incrementing a counter reading for the class by a defined amount.

In other words, according to the invention, the measured variable or each measured variable and/or the calculated variable or each calculated variable can be stored on the basis of at least one freely definable trigger condition, specifically in such a way that, for the respective variable to be stored, it is possible to define a number and width of classes and intervals for the variable, wherein if the respective variable to be stored falls in one of the classes, the counter reading for this class is increased by a defined absolute amount.

Within the concept of the present invention, for the first time a motor vehicle control device is proposed wherein both measured variables and calculated variables can be stored on the basis of freely defined trigger conditions, specifically in such a way that the storage supports statistical evaluation of the variables. The number and width of classes can thus be freely defined for each variable to be stored. When the respective variable to be stored falls in one of the freely defined classes, a counter reading for this class is increased by a defined absolute value. Accordingly, within the sense of the present invention a specific value is not stored for a variable to be stored but instead it is determined whether the specific value can be assigned to a class for the variable to be stored. The storage of the variables is carried out here without reaction and thus without influencing other functions or functionalities of the motor vehicle control device.

The motor vehicle control device according to the invention has means for receiving at least one measured variable, means for calculating at least one variable and means for storing the measured variable or each measured variable and the variable to be calculated or each variable to be calculated.

According to the invention, the measured variable or each measured variable and/or the calculated variable or each calculated variable can be stored on the basis of at least one freely definable trigger condition. For example a time interval and/or an event occurring during operation can be defined as a trigger condition. As a time interval it is possible to provide, for example, that a measured variable and/or calculated variable is stored every 100 milliseconds, once per journey or once a month. As an event which occurs during operation it is possible, for example to define the starting of an engine or the shutting down of an engine. Furthermore, a plurality of trigger conditions for storing a measured variable and/or calculated variable can be combined with one another. All the input variables, output variables and calculated variables which are present in the engine controller can be freely selected as trigger conditions.

The sense of the present invention includes storing the measured variable or each measured variable and/or the calculated variable or each calculated variable as a function of the freely definable trigger condition in such a way that, for the respective variable to be stored, a number and width of classes and intervals can be freely defined for the variable. If, for example, an engine speed is to be stored as the measured variable, it is possible to provide that rotational speed intervals are defined as classes for the engine speed. The classes can have the same or different widths here. In the case of the engine speed, this means that, for example, it is possible to provide that each class or each interval has a width of 500 rpm. Then, if the classes have different widths it is possible for each class to cover a different rotational speed range.

Then, if the respective variable to be stored, falls in one of the freely definable classes, according to the invention a counter reading for this class is increased by a defined absolute amount. Accordingly, it is not the specific value of a variable to be stored which is stored but rather information indicating whether the variable to be stored falls in one of the classes which is defined for said variable is stored, wherein case the corresponding counter reading is then incremented by a defined absolute value, for example by 1.

Other features which are considered as characteristic for the invention are set forth in the appended claims.

Although the invention is illustrated and described herein as embodied in a Motor Vehicle Control Device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE of the drawing is a bar graph diagram illustrating ten classes for a variable k and corresponding counter readings.

### DETAILED DESCRIPTION OF THE INVENTION

Referring now to the FIGURE of the drawing in detail, there is shown, purely by way of example, a diagram wherein a total of ten classes kᵢ, i=1-10 have been defined for a variable k to be stored, the level of the bar which is assigned to a class kᵢ indicating the counter reading of the corresponding class. The class k₇ in the FIGURE has the highest counter reading.

When and if a defined trigger condition is met, it is tested whether the variable k to be stored can be assigned to one of the classes kᵢ, the counter reading for this class then being increased.

When and if the counter reading has reached a maximum permissible value in one of the classes for a variable to be stored, the counter readings of all the classes for this variable to be stored can be reduced by the same factor. Preferably, all the counter readings for this variable to be stored are halved. This ensures, that, on the one hand, no faults arise due to maximum permissible counter readings being exceeded, and that, on the other hand, the relative distribution of the variable to be stored in the classes defined for said variable is maintained.

The above storage of the measured and/or calculated variables is carried out according to a so-called polling method. This means that the variables are merely interrogated without reacting on other functions or functionalities of the motor vehicle control device.

Furthermore, within the concept of the present invention it is possible to provide that the method of functioning of the motor vehicle control device is modified if the counter reading has reached a maximum permissible value in at least one of the classes for a variable to be stored. Furthermore, warning messages or fault messages can be generated in order to indicate the same, for example, to a driver and to prompt a visit to a workshop.

The storage of the measured variable or each measured variable and/or the calculated variable or each calculated variable in the motor vehicle control device is preferably carried out in the form of histograms. However, it is also possible to use other types of storage or types of display for stored variables.

1. A motor vehicle control device, comprising:
an input for receiving at least one measured variable;
means for calculating at least one variable to define a calculated variable;
a memory for storing the at least one measured variable and/or the calculated variable, wherein the measured variable and/or the calculated variable is stored on a basis of at least one freely defined trigger condition, wherein, for a respective variable to be stored, a number and width of classes and intervals are defined for the variable, and, if the respective variable to be stored falls into one of the classes, a counter reading for the class is increased by a defined amount.

2. The motor vehicle control device according to claim 1, wherein the measured variable and/or the calculated variable is stored on a basis of a plurality of freely definable trigger conditions.

3. The motor vehicle control device according to claim 1 configured as an engine control device.

4. The motor vehicle control device according to claim 1 configured as a gearbox control device.

5. The motor vehicle control device according to claim 1, wherein, when the counter reading has reached a maximum permissible value in one of the classes for a variable to be stored, the counter readings of all classes corresponding to the variable to be stored are reduced by a common factor.

6. The motor vehicle control device according to claim 1, wherein, when the counter reading has reached a maximum permissible value in at least one of the classes for a variable to be stored, the functionality of the motor vehicle control device is modified and/or a warning message is generated.

7. The motor vehicle control device according to claim 1, wherein, when the respective variable to be stored falls in a given class, the counter reading for the given class is increased by 1, and when the counter reading has reached a maximum permissible value, the counter readings of all the corresponding classes for the given variable to be stored are halved.

8. The motor vehicle control device according to claim 1, wherein a time interval and/or events which occur during operation are defined as a trigger condition.

9. The motor vehicle control device according to claim 2, wherein a plurality of trigger conditions are combined with one another.

10. The motor vehicle control device according to claim 1, wherein the variable or each variable is stored in the form of a histogram.

11. The motor vehicle control device according to claim 10, wherein the histogram is stored in an engine control unit and the histogram is deleted only after a request by an external command or after a defined state has been reached.

12. The motor vehicle control device according to claim 11, which comprises a volatile memory and a nonvolatile memory, and the histogram is stored in said volatile memory and in said nonvolatile memory.

13. A method of operating a motor vehicle control device, comprising:
receiving at least one measured variable related to an operation of the vehicle in the motor vehicle control device;
calculating at least one calculated variable from the measured variable;
storing the at least one measured variable and/or the calculated variable on a basis of one or more freely definable trigger conditions;
defining, for a respective variable to be stored, a number and a width of classes and intervals; and
if the respective variable to be stored falls into one of the classes, incrementing a counter reading for the class by a defined amount.

14. The method according to claim 13, wherein, if the counter reading has reached a maximum permissible value in one of the classes for a variable to be stored, reducing the counter readings of all the corresponding classes for the variable to be stored by a common factor.

15. The method according to claim 13, wherein, if the counter reading has reached a maximum permissible value in at least one of the classes for a variable to be stored, modifying a functionality of the motor vehicle control device and/or generating a warning message.

16. The method according to claim 13, wherein, if the respective variable to be stored falls into a given class, incrementing the counter reading for the given class by 1, and when the counter reading has reached a maximum permissible value, reducing the counter readings of all the corresponding classes for the variable by half.

17. The method according to claim 13, which comprises defining a time interval and/or events that occur during operation as a trigger condition.

18. The method according to claim 13, which comprises storing the variable or each variable in the form of a histogram.

19. The method according to claim 18, which comprises storing the histogram in an engine control unit and clearing the histogram only after receiving an external command or after a defined state has been reached.

20. The method according to claim 18, which comprises storing the histogram in a volatile memory and in a nonvolatile memory.
